(19) United States
(12) Patent Application Publication
(10) Pub. No.: US 2025/0280770 A1
(43) Pub. Date: Sep. 11, 2025

(54) MODULAR FARMING FACILITY

(71) Applicant: 12832429 CANADA INC., Saint-Jean-sur-Richelieu (CA)

(72) Inventor: Jean CÔTÉ, Morrisonville, NY (US)

(21) Appl. No.: 19/073,930

(22) Filed: Mar. 7, 2025

Related U.S. Application Data
(60) Provisional application No. 63/563,278, filed on Mar. 8, 2024.

(51) Int. Cl. A01G 9/14; A01G 9/24; E04H 5/08

(52) U.S. Cl. CPC A01G 9/14; A01G 9/246; E04H 5/08

(57) ABSTRACT

The present disclosure relates to modular building structures arranged to form a facility. Modular building structures can be designed to fulfill a large variety of dedicated functions depending on the purpose of the overall facility. For example, an indoor farming facility can be constructed from different modular building structures having unique functions such as growing modules, corridor modules, washroom modules, office modules, etc. For the facility to function properly, the design of the modular building structures can be adapted to only include elements integral for the modular building structure's unique function or include elements that serve general needs for the facility. Modular building structures can easily be assembled through connection components, which also facilitate the addition or removal of modular building structures from the facility.

The present application claims priority from U.S. provisional patent application No. 63/563,278 filed on Mar. 8, 2024, the contents of which are incorporated herein by reference.

### TECHNICAL FIELD

This document relates to indoor farming, namely the assembly of a farming facility.

### BACKGROUND

Indoor farming is well known for having many advantages over traditional agriculture methods such as having cultivating parameters that can be controlled or even automated, harvesting crops year-round regardless of geographic location and having more predictable yields.

The conception of these indoor farms typically involves the construction of a building in which the entire facility will be contained. The construction of this building can require lengthy on-site work for laying of the foundation, erecting the frame, completing interior and exterior fixtures and other time-consuming construction tasks. After the building is constructed, specialized equipment and systems, such as mobile vertical growing structures, security systems, shipping equipment, analytical equipment as well as others that have functions beneficial for indoor farming may be installed within to create a functional farming facility.

It has also been demonstrated in prior art that indoor farming may be executed with a modular structure, typically within a shipping container; usually 8 ft×20 ft or 8 ft×40 ft in size; equipped with appropriate systems to control air temperature, water temperature, humidity levels, carbon dioxide levels and ventilation to obtaining optimal growth; and designed to maximize yield per square foot. While these modules have the advantage of being independent, scalable and turnkey, they however do not allow for a plurality of modules to be interconnected as to allow one module to benefit from the functioning of another.

Furthermore, within a building, modules with specific functions may be added to form specialized chambers such as in patent “Secure plant cultivation chamber”, US 2019/0323253 A1, published on Oct. 24, 2019. These specialized chambers can satisfy necessary functions for indoor farming, such as grow rooms, laboratories, processing rooms as well as others to create a whole working facility. However, creating a facility in this way still requires the laborious effort to create a building to house these modules.

Therefore, there is a need to develop a structure and method that benefits from the advantages offered by modular farming facilities, while allowing a flexibility of dependency between modules and only requiring the structure inherent to these modules to produce the global structure of the facility. This would allow a facility to be easily built and easily expandable while still maintaining the specialized and distinct modules within the facility.

### SUMMARY

The present disclosure relates to modular building structures arranged to form a facility. Modular building structures can be designed to fulfill a large variety of dedicated functions depending on the purpose of the overall facility. For example, an indoor farming facility can be constructed from different modular building structures having unique functions such as growing modules, corridor modules, washroom modules, office modules, etc. For the facility to function properly, the design of the modular building structures can be adapted to only include elements integral for the modular building structure's unique function or include elements that serve general needs for the facility. Modular building structures can easily be assembled through connection components, which also facilitate the addition or removal of modular building structures from the facility.

A broad aspect is an indoor farming facility that includes a large number of pre-equipped modular building structures configured to be connected together to form the facility. A large set of the pre-equipped modular building structures are indoor farming units having as their use, operation, function or task a growing of plants, the indoor farming units adapted to receive external heating and/or air conditioning fluid. A remainder of the pre-equipped modular building structures provides: heating and/or air conditioning to provide heating and/or air conditioning fluid to the indoor farming units; and a shipping area for shipping of plant products; as their use, operation, function or task. The facility includes a corridor for accessing at least the indoor farming units and the shipping area, and the facility includes at least one of: a corridor extending across at least some of the pre-equipped modular building structures, the at least some of the pre-equipped modular building structures have at one end corridor space and an opening in at least one side wall; a plurality of corridor modular building structures adjoined to ends of said pre-equipped modular building structures.

In some embodiments, the pre-equipped modular building structures may have at one end corridor space and an opening in at least one side wall such that a corridor may extend across at least some of said pre-equipped modular building structures.

In some embodiments, the remainder of the pre-equipped modular building structures may further provide toilet facilities.

In some embodiments, the facility may further include a plurality of corridor modular building structures adjoined to ends of the pre-equipped modular building structures.

In some embodiments, the facility may comprise two or more floors, the remainder of the pre-equipped modular building structures may further provide interior staircase equipment.

In some embodiments, the facility may include an exterior fire escape staircase.

In some embodiments, remainder of the pre-equipped modular building structures may further provide office space partitions.

In some embodiments, modular building structure may further include connection components to adjoin adjacent modular building structures of the facility.

In some embodiments, the remainder of the pre-equipped modular building structures may possess a plurality of different uses, operations, functions or tasks.

In some embodiments, the modular building structures may further include a floor with a length and width and a designated grow area filled with the indoor farming units covering most if not all of the floor and extending across all of said width, a plurality of vertical plant growing support structures each having a number of plant receptacles arranged above each other extending from the floor to a ceiling of the modular building structure and a conveyor system arranged to support the plurality of vertical plant growing structures to be movable along at least one loop path such that the plurality of vertical plant growing support structures fill the designated grow area.

In some embodiments, the facility may further include a decontamination system located in at least part of one of said modular building structures.

A broad aspect is a method for constructing a facility. The method includes using a floorplan of the facility to guide building a number of modular building structures at a first factory location; shipping at least some of the modular building structures to a second factory location and equipping the modular building structures at the second factory location to provide pre-equipped modular building structures able to satisfy a use, operation, function or task indicated by the floorplan; shipping the number of modular building structures to an installation site; and connecting the number of modular building structures together to form the facility in accordance with the floorplan.

In some embodiments, some of the modular building structures may be equipped at the first factory location to provide pre-equipped modular building structures able to satisfy a use, operation, function or task indicated by the floorplan.

In some embodiments, the method may further include shipping at least some of the modular building structures to a third factory location and equipping the modular building structures at the third factory location to provide pre-equipped modular building structures able to satisfy a use, operation, function or task indicated by the floorplan.

In some embodiments, the connecting step may further include using connection components of the modular building structures to adjoin adjacent modular building structures.

In some embodiments, connecting may further include vertically stacking modular building structures in accordance with the floorplan defining multiple floor levels.

In some embodiments, connecting may further comprise connecting the modular building structures of at least a ground floor to ground engaging members.

In some embodiments, the facility may be an indoor farming facility, a large set of the pre-equipped modular building structures being grow chambers

### BRIEF DESCRIPTION OF THE DRAWINGS

The invention will be better understood by way of the following detailed description of embodiments of the invention with reference to the appended drawings, in which:

FIG. 1a is an isometric view of a prior art modular building frame;

FIG. 1b is an isometric view of a prior art modular building structure as in FIG. 1a with a roof, walls, windows and door installed;

FIG. 1c is an isometric view of a prior art modular building structure, as in FIG. 1b, stacked;

FIG. 1d is an isometric view of multiple modular building structures, as in FIG. 1b, that are connected together to form a facility;

FIG. 2a illustrates a side view showing a portion of a base of a frame of a modular building structure adapted with a hook for guiding and interconnecting an adjacent modular building structure;

FIG. 2b illustrates a side view showing a portion of a base of a frame of two modular building structures properly aligned and connected together with reenforcing hardware;

FIG. 3 is a modular building structure pre-equipped with ducts;

FIG. 4 is a schematic plan view of an HVAC module within a facility

FIG. 5 is a side break away view of a prior art indoor farming unit;

FIG. 6a illustrates a first example of a floor plan of a facility having modular building structures providing a corridor;

FIG. 6b illustrates a second example of a floor plan of a facility having modular building structures having an end portion providing a corridor;

FIG. 6c illustrates an example of a floor plan similar to the one illustrated in FIG. 6a for an additional level of the facility;

FIG. 7 is a plan view of two side by side indoor farming modules showing schematically a conveyor loop arrangement of plant supports;

FIG. 8 is a block diagram for the conveyor system of the indoor farming module of FIG. 7;

FIG. 9 is an isometric view of a prior art conveyor system for indoor farming;

FIG. 10 is a frontal view of a plant growing apparatus' segment that contains a rotational mechanism;

FIG. 11a is a plan view of a grow chamber made from three modular building structures showing schematically a conveyor loop arrangement of plant supports filling the grow chamber with an opening in the loop allowing for access to inaccessible areas within the grow chamber;

FIG. 11b is view similar to FIG. 11a showing a person in the opening;

FIG. 11c is view similar to FIG. 11a showing a person in the opening moved to a location where maintenance is required.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. Furthermore, the words “herein”, “above”, “below” and words of similar implication, when employed in this application, refer to this application in its entirety rather than to any particular sections of this application.

“Modular building structure” as used herein is intended to mean a part of a building that can be transported by trailer and connected to other modular building structures to form a larger building. A modular building structure intended to be adjoined to another modular building structure while having at least one of its sides exposed to the outside can have an exterior wall structure on said exposed sides. Furthermore, a modular building structure intended to be adjoined to another modular building structure processing at least one side located within a larger building can either have an interior wall structure or no wall structure on said interior side. A modular building structure can have no roof structure when a top is intended to adjoin another modular building structure above it, whose floor may act as a ceiling.

“Pre-equipped modular building structure” as used herein is intended to mean a modular building structure having equipment installed in a fixed manner in the modular building structure to provide required infrastructure for the use of the modular building structure for a specific use, operation, function or task, wherein the equipment is installed prior to transport to an installation site such that installation of essential equipment at the installation site is not required.

“Facility” as used herein is intended to mean a building structure made by interconnecting a number of modular building structures at a given installation site. In some cases, the number of modular building structures can be more than 10.

“Sanitization equipment” as used herein is intended to mean equipment for preventing or reducing the risk of an interior of the indoor farming facility from being exposed to contaminants, namely insects, funguses, viruses or bacteria, that can harm plant growth. Such contaminants can be airborne or they can be carried by footwear and clothing of people entering the facility. Sanitization equipment can include air filtration, positive pressurization of the interior of the facility, washing and/or cleaning equipment, chemical disinfectant sprayers, etc.

From the foregoing it will be appreciated that, although specific embodiments have been described herein for purposes of illustration, various modifications may be made without deviating from the spirit and scope of the teachings. Accordingly, the claims are not limited by the disclosed embodiments.

The following is a detailed description of embodiments of the disclosure depicted in the accompanying drawings. The embodiments are in such detail as to clearly communicate the disclosure without limiting the anticipated variations of the possible embodiments and may encompass all modifications, equivalents, combinations and alternatives falling within the spirit and scope of the present disclosure. It will be appreciated by those skilled in the art that well-known methods, procedures, physical processes and components may not have been described in detail in the following so as not to obscure the specific details of the disclosed invention.

The present disclosure describes a structure that may be formed from a plurality of distinct modules, formed from module building structures described below, that can be assembled in order to achieve functional and structural requirements for the facility to be operational, as well as the method of assembling said structure.

The disclosed structure may comprise of a plurality of modules which may be understood to be a distinct unit, formed from module building structures described below, that may have a dedicated function (indoor farming modules, processing rooms, offices, washrooms, etc.) within a network of modules, said network defined herein as a facility. The use of these modules within a farming facility may provide certain advantages to non-modular indoor farming facilities, including physical separation of crops in different modules, distinct growth parameters for crops in different modules, and scalability of the farming facility.

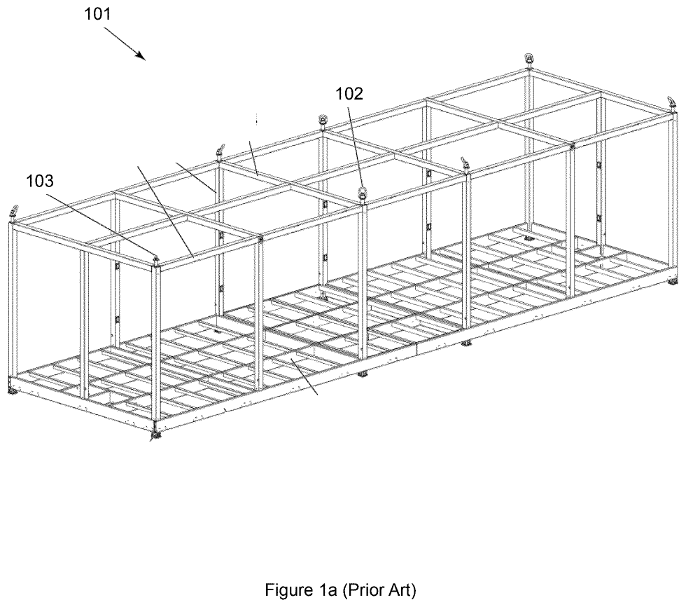

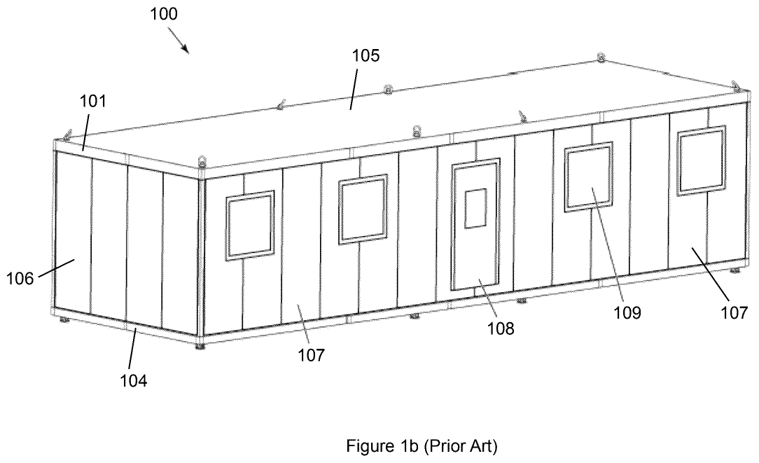

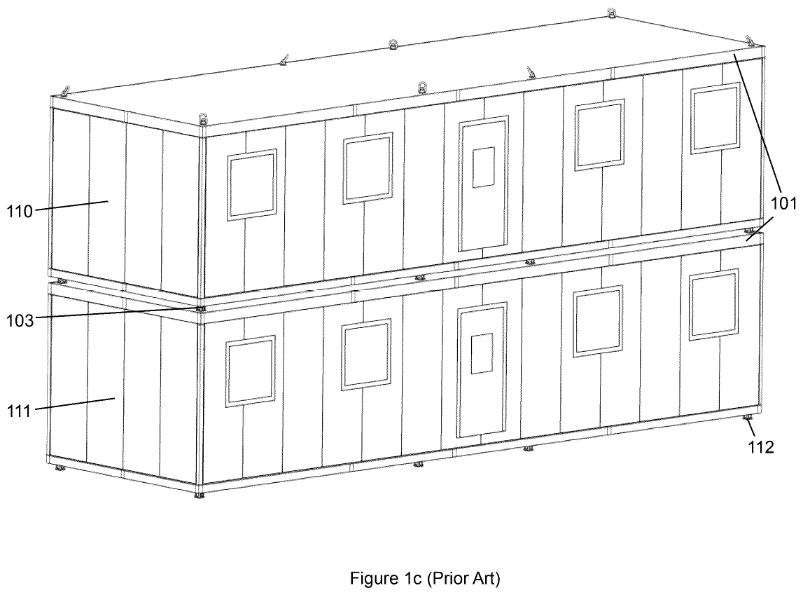

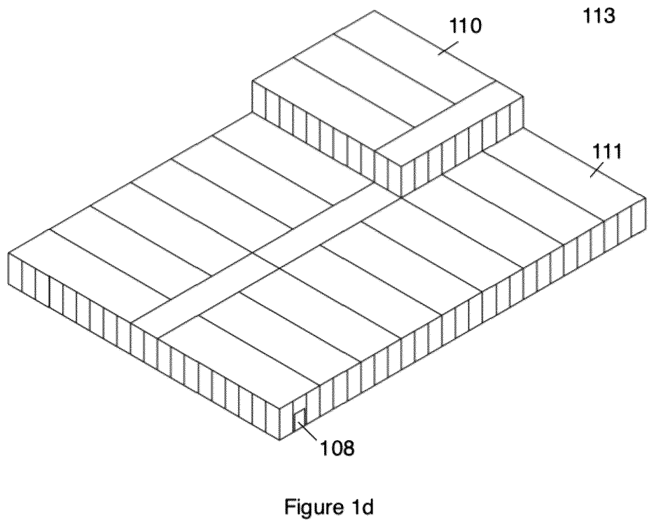

In a preferred embodiment, the structural elements of a module may be provided by a modular building structure such as the one described in published application “Modular fabrication of structures”, US20240011277A1 published Jan. 11, 2024 shown in FIG. 1. The modular building structure 100 shown in FIG. 1b may comprise of a rigid frame 101 shown in FIG. 1a composed of supporting beams which can be fabricated to have a number of lengths, widths and heights, or may even be fabricated to be in different shapes than a rectangle depending on the desired shape of the facility. The arrangement of the modules may be indicated in a floorplan for the facility. It should be appreciated that the rigid frame 101 may be constructed in a variety of materials such as wood, metals, metal alloys, polymers, and concrete. The choice of material and the treatment of material may depend on a variety of factors including but not limited to availability, strength, rust-resistance, conductance, anti-microbial properties, weight as well as others known by those skilled in the art. As shown in FIG. 1a the frame may also comprise of lifting interfaces 102 to allow for the modular building structure to be easily transported vertically as well as horizontally. Stacking interfaces 103 may also be added to the frame 101 to allow modular building structures to be connected vertically.

The frame 101 may be fabricated to accommodate other structural elements shown in FIG. 1b such as a floor 104, a ceiling 105, walls 106 which may be formed of insulated panels 107, doors 108, windows 109. The installation of insulated panels 106 as part of the modular building structure 100 may be particularly beneficial for farming facilities by helping maintain an appropriate temperature by minimizing heat loss. Walls 106 may allow separation between modules. Doors 108 may provide an exterior entrance to the facility or an entrance to different modules within the facility. Windows 109 may be useful for facilities where the sun is used as a light source, for ventilation, for temperature regulation or for aesthetics, however these functions may be fulfilled by other devices such as LED lights and HVAC (Heating, Ventilation, and Air Conditioning) systems. It should also be appreciated that the removal of any of the structural elements enumerated above may be justified considering the overall the design of the facility or desired association between modular building structures as further described below.

The modular building structure as described above may be further designed in such a way that allows for it to be easily shipped by transportation vehicles such as trains, boats and freight trucks due to its size and shape without necessarily the need for specialized transportation equipment.

The stacking interfaces 103 of the frame 101 may facilitate vertical construction as described in the referenced state of the art and illustrated in FIG. 1c. The top modular building structure 110 may be fixed to a lower modular building structure 111 through adjacent stacking interfaces. The bottom stacking interface 103 of the lowest modular building structure 111 may be converted to function as supporting feet 112 for the facility which may be fixed to the ground with ground engaging members in ways known to those skilled in the art, thus a foundation may not be needed. Furthermore, modular building structures may be connected vertically or horizontally to create a fixed multi-module facility 113 as shown in FIG. 1d through different connection components. The arrangement of the modules may be indicated in a floorplan for the facility. While access to the different levels of the facility may not be necessary, stairs elevators or other apparatuses which permit access to different levels of the facility may be added to the design of the facility. More details concerning the construction may be found in the above referenced published application.

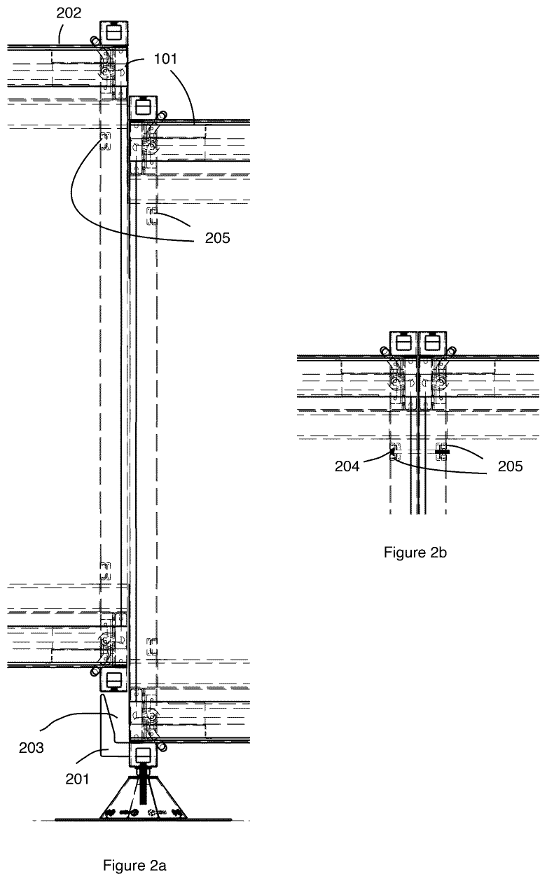

In a preferred embodiment, a connection component may be as illustrated in FIG. 2a. Hooks 201 may be included as part of the frame manufacturing process to the bottom of the frame 101. Hooks 201 may be added along the length and/or width of the frame in an appropriate number to allow the connection between two modular building structure frames 101 to be stabilized. Hooks may also be omitted from lengths or widths of the frame 101 depending on the position of the modular building structure in respect to others within the facility. When a modular building structure possessing hooks 201 is positioned at installation, the adjoining modular building structure 202 is lifted, with appropriate lifting machinery, to allow for a hook 201 to self-align in the designed position with the adjacent frame 101. To accomplish this, hooks may be distanced at a certain length for the hooks 201 to be positioned along the exterior of supporting beams, however other guiding mechanisms and designs to allow alignment are known to those skilled in the art. The gap of the hook 203 may be of appropriate size to allow a beam of the frame of the adjacent modular building structure to rest within the gap 203 and throat of the hook for example, however they may also account for other structural elements interacting with the connection such as wall between adjoining modular building structures, soundproofing or other similar elements. Therefore, when adjacent modular building structures are aligned appropriately, the two structures may be connected by inserting a portion of the adjacent modular structure's frame designated to fit within gap 203 thereinto. To further stabilize the connection, reenforcing hardware 204, such as bolts, may be used at stabilization points 205 to solidify the connection as shown in FIG. 2b. A bolt may be passed through a threaded hole aligned throughout connecting modular building structures and secured at the other end, however other methods to further stabilize the two modular building structures are known to those skilled in the art. There may be as many stabilization points 205 as required to achieve appropriate connection integrity. While support for each modular building structure may be attributed to each structure individually, connecting two structures together with the described connection component may provide a certain amount of support to adjacent containers in such a way that support footing only be required to certain critical points of the modular building structures.

In another embodiment, a connection component may have a multitude of parts that may be distanced from each other or may be a singular part which allows a connection between modular building structures. A protruding member of one structure may be securely attached through a slot, securing member or another mechanism to the adjacent structure. Examples of other connection components may include a protruding member of one structure entering a slot in the adjacent structure and being secured in place with a pin. A pin may also be unnecessary to securing the connection depending on the design of the connection component. Other variations of integrated connection components should also be considered as protected by the scope of the present disclosure.

While the above preferred embodiment describes a structure such as the one found within the reference, it should be appreciated that any reasonable variation of the above-described structure which provides structural elements to a module should also be applicable as a modular building structure as disclosed herein. Examples of such variation may include the use of a shipping container and adding certain advantageous components described above thereto, the use of a shipping container with different components that provide certain construction advantages, a modular building structure at the lowest level fixed to a foundation or any other modular building structure variation known to a person skilled in the art able to be used as providing structural elements to a module or part of a module described below for the facility that may perform a dedicated function.

It should be appreciated that these modular building structures allow the consumer to adapt the structure of modules, and thus the structure of their facility, to their particular needs allowing for more flexibility. A module may therefore be considered be constructed from a single modular building structure in which a system or device may be enclosed that allows a dedicated function to be executed, however, a module may also be considered to be constructed from two or more modular building structures that are connected through connection components described herein. In the case that a plurality of modular building structures are connected together to form a single module, certain interior walls, floors or ceilings of the modular building structures may be removed to increase the exploitable space within a module in such a way that only one door is needed to enter into a space contained within the walls of a module that is equivalent to at least two modular building structures. The benefit to this design resides in the ability to increase the size of a module while still profiting from the autonomous nature of each module within the facility. Furthermore, the specific design of the modular building structure described above may permit easy transportation by common transportation vehicles without sacrificing the flexibility of module size and shape. These modules may individually contain structural element as described above, however the repetition of structural elements among different modules of a facility should in no way be considered mandatory.

Due the dedicated functionality of each module within a facility and the possibility for easy transportation of a modular building structure, the customization of a modular building structure for it to be able to fulfill its dedicated function as, or as part of, a module may be executed before delivery to the installation site for the end user (being received by the end user). Customization of the different modular building structures may include plumbing systems; electrical wiring; specialized systems such as mobile growing systems as described below, centralized HVAC units, compressors; furniture; security systems; or other systems, designs or devices that require a qualified person (engineer, electrician, plumber, etc.) or a product or service from a manufacture to obtain the desired result. By customizing each modular building structure while taking into account its contribution to the facility, the installation effort required upon delivery may become quite minimal allowing the consumer to have a turnkey, or almost turn-key, facility through the use of these pre-equipped modular building structures. The fabrication and customization of the pre-equipped modular building structure may be executed at a single manufacturing location, however, the fabrication and customization of these modular building structures may also be delegated or even outsourced to different manufacturing locations or companies. This may also allow for the possibly for the modules formed by these modular building structures to be certified as conform to certain regulations which the facility may need to respect. Depending on which portion of the modular building structure a certain manufacturing location is equipped to supplement, said manufacturing location may complete their designated portion before either sending it another manufacturing location to complete another portion, sending it to a shipping center to validate conformity before sending it to the installation site (for the end user), or sending it to the installation site (for the end user).

While modules may have a dedicated function within a facility, it may be understood that all necessary technical element (such as compressors, HVAC systems, water tanks, dehumidifiers, electrical circuits etc.) may be already installed within the modules in such a way that a module may be independently functional from other modules within the facility. This has the main advantageous of being able to have complete control over each module individually. Furthermore, it allows modules to be moved, sold, withdrawn from service, or repaired without any implication, or effect on other modules within the facility. However, the increased costs of machinery, risk of breakdown or difficulty of repair may also be associated with functionally independent modules.

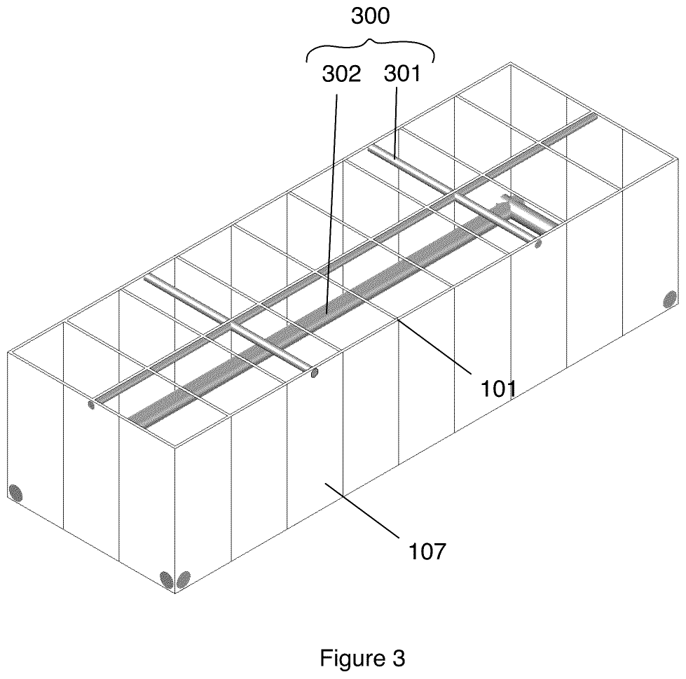

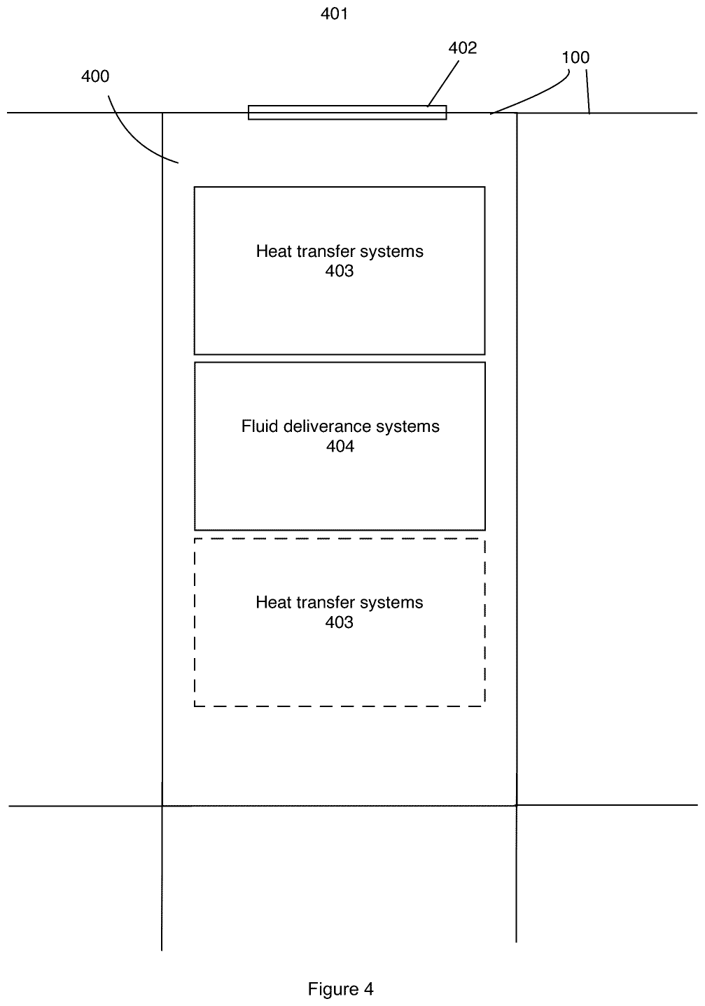

In light of the type of module described above, it should be understood that the coordination between modules of an indoor farm facility, for example, may allow certain technical elements (such as compressors, HVAC systems, water tanks, dehumidifiers, electrical circuit boards etc.) to be located in a centralized module while their functionality may be used in some other modules. To exploit the functionality of devices found in other modular building structures, ducts 300 as shown in FIG. 3 may be pre-equipped within a modular building structure to allow for easy connection between modular building structures. In an exemplary embodiment the ducts 300 are used to connect modules to a centralized HVAC unit. Air supply ducts 301 and air return ducts 302 may be installed with appropriate insulation within the modular building structure. The air supply ducts 301 may deliver conditioned air produced inside the dedicated HVAC module at proper humidity and temperature, or refrigerant fluid, to a grow module for example while the air return ducts 302 draw air, or refrigerant fluid, out of the module for cleaning and conditioning steps at the dedicated HVAC module. While in this exemplary embodiment the air is treated only at the HVAC module, it is understood that air may be treated at the destination module, or at another location depending on the technical design of the system while following local regulations. Other designs of different centralized HVAC system types than that described are thus known by a person skilled in the art. The connections of ducts 300 between modular building structures may be facilitated through connection hardware. Furthermore, in the case where modules may be functionally independent as described above, these connection ducts 300 may also be used for multi-modular building structure modules in order to connect these modular building structures together to allow them to function cohesively either at the initial installation date or allow additional modular building structures to be added to modules at a later date. The centralized HVAC unit 400 as shown in FIG. 4 may need at least one of the sides of the modular building structure 100 to be exposed to the outside environment 401 through grates 402 for example to permit the airflow required by different components of the HVAC system either for input or as an exhaust. The exposed side may be the ceiling of an upper-level module, or any wall exposed to the outside environment. The HVAC module may also contain fans, heat exchangers and/or other systems that transfer heat 403 to or from a working fluid (e.g. heating fluid, air conditioning fluid, etc.). Also, the HVAC module may contain compressors, pumps, associated motors or other systems that allow the deliverance of working refrigerate fluid 404 towards targeted areas through ducts 300. As mentioned above, the process of conditioning air may occur outside the HVAC module, therefore additional necessary heat transfer systems 403 which may be required either in the HVAC module or within other modules to properly condition the air to the required specifications may be installed. Advantages of the configuration of this type of facility may include the customization of only specific modular building structures for specific technical elements and the facility of repair of said technical elements. To further demonstrate these advantages, in the case were the centralized HVAC system fails, a new centralized HVAC system module may be delivered to the facility and replace the faulty module. Therefore, the new centralized HVAC modules is simply connected to other modules through connecting ducts 300 described above without the need to intervene within other modules. Furthermore, the physical distancing of essential technical systems within facilities that contain modules with restricted access may be particularly advantageous. This facility layout would allow qualified workers to repair an essential system, for example the HVAC system in the exemplary embodiment above, without the need for them to pass through security clearance procedures as would be the case if said HVAC system was located directly within the restricted access module. While a centralized HVAC system module was described above, the ducts 300 or separate ducts, analogous to the ones described above, may further provide a structure for a multitude of essential technical elements for the functioning of the modules or even the facility as a whole, including but not limited to electrical, pneumatic, ventilation and plumbing systems.

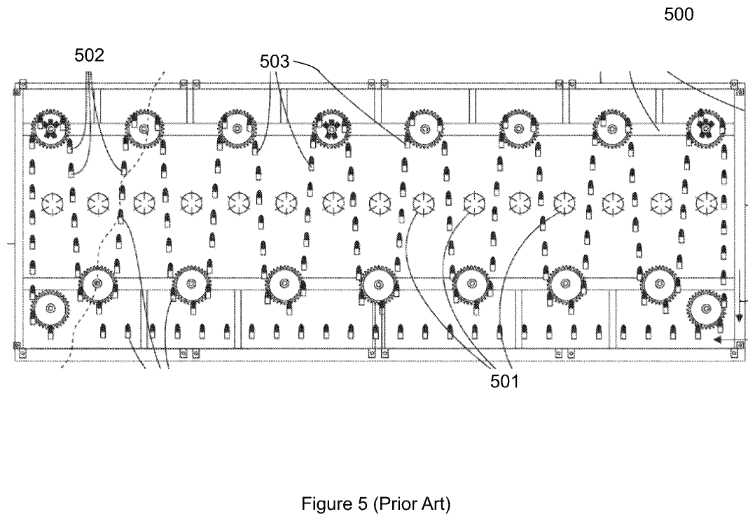

Another exemplary embodiment of a dedicated function for a module within the disclosed facility may be for indoor farming activities for plants. It is well known in the state of the art that indoor farming units or entire farms may be found within a modular building structure or as modules within a building as described above. One of these indoor farming units 500 is illustrated in FIG. 5 from patent “Method and Apparatus for Growing Plants” US20120279122A1, published Apr. 30, 2019. The installation of an indoor farming unit 500 as described below within a modular building structure to be part of a facility may be defined herein to be an indoor farming module. Advancements in technology for indoor farming have improved space utilization through different structures, systems and arrangement that maximize yield by square-foot. This can be accomplished by exploiting vertical space within a unit with the use of certain plant growing apparatuses, described below, which contain plants and shall be defined to include vertical growth columns, vertical growth walls, vertical stack plant assemblies or growing machines as the case in the present exemplary embodiment. The plant growing apparatuses enumerated above, as well as other structures in which plants may be organized and supported during their growth are described within the prior art or are known to those skilled in the art. Certain methods may concentrate on increasing the designated growth area of the indoor farming unit 500 to a maximum within the modular building structure 100, while still maintaining space for all other necessary production related activities. The term “designated growth area” is employed herein to indicate the space occupied solely by the plants during their growing cycle as well as associated essential systems to allow their growth or other systems required for the functioning of these essential systems and should not be interpreted to mean to include a space for; workstations for propagation, machines, harvesting or other similar activities; passage corridors for workers; storage areas; or other areas dedicated to support production but are not essential to growth. Essential systems for plant growth 501 required for these indoor farming units 500 shall herein be considered to include but not be limited to irrigation systems, nutrient delivery systems, temperature control systems, lighting systems, gas concentration control systems, electromagnetic systems, pest control systems, hydroponic systems, as well as others known by those skilled in the art. Furthermore, it is known by a person skilled in the art that these essential systems 501 may be fully or partially automated through the addition sensors, controllers and user interfaces as components to a control system. Other methods may concentrate on optimizing the foliage density of a given indoor farming unit 500 to a maximum in such a way as to allow the designated growth area to completely fill the modular building structure 100 by using a conveyor system, as is the case for the present example, while designating other units or spaces for activities that support production. These systems may be installed in any beneficial location known to those skilled in the art within the indoor farming unit 500. Components of essential systems for plant growth 501 or plant supports 502 may be, as a whole or in part, stationary or mobile depending on the design system. It has already been described in prior art that conveyor systems 503 be used to move components throughout a unit to maintain optimal growth conditions, to transport plants to a designated workstation in which a worker may accomplish necessary tasks such as weeding, harvesting, assessing, pruning, planting or other related tasks, instead of physically having the move throughout unit, as well as other advantages associated with the mobility of these components. These systems are described in greater detail below as well as in the patent referenced above.

As a continuation to the exemplary embodiment of a module being dedicated an indoor farming function, an associated module may be dedicated a decontamination chamber function. It is well known in the state of the art that facilities which house biological material, especially when considered a commercial entity, are required to respect local regulations concerning biosecurity. Requirements detailed in these regulations may refer to decontamination procedures, systems in order to protect the interior environment of the facility material or the exterior of the facility from biological material within the facility. Biological material may herein be understood to include microorganism, undesirable seeds, unsought pollen, insects, rodents, birds or any other biological entity that may be detrimental to the performance of the facility. Furthermore, the modular structure of the facility described herein may also be particularly advantageous when certain activities or stored objects must be isolated from others to conform to biosecurity regulations. The full scope and requirements dealing with biosecurity within a facility as well as the associated systems are known to those skilled in the art.

While the exemplary embodiment of a dedicated function of a module described above pertains to a module which allow the growth of plants, other dedicated functions may be attributed to modules within the facility. Modules may be used to raise animals or to produce animal-based products, as well as contain specialized industrial equipment for specific processes, offices, washrooms, laboratories cafeterias, kitchens, bedrooms etc. Furthermore, the module may only function as a corridor or storage area which may not require any customization or pre-equipment to the modular building structure. The facility may not even be used for indoor farming but rather serve as a structure for another type of activity whether it be residential or commercial (such as a lodging facility, an office building, a manufacturing complex, a mall, etc.). Due to the modularity and potential customization of the modular building structures, it is impossible to describe every possible dedicated function that a module may have within the facility. The design of the disclosed structure is flexible allowing the consumer to adapt said structure to their needs for their facility. Therefore, all possible functions for a module that allow for the proper functioning of the desired facility should therefore be encompassed within the scope of this disclosure.

Another embodiment of the disclosed structure may allow for a module to have multiple functional elements while still requiring other modules for certain functionalities in such a way that allows a module to be assigned a dedicated function while also containing elements that may contribute to the overall cohesion of operations within the facility. An example of such a multi-functional module may be a module customized to contain an indoor farming unit while also containing a corridor section (space) to facilitate the passage from one modular building structure an adjacent one. Another example may be the combination of an entrance modular building structure equipped with identification systems and lockers while also containing a decontamination system before entering a clean environment. Again, due to the potential customization of the modular building structures, it is impossible to describe every possible function and combination of functions that a module may have within the facility. The design of the disclosed structure is flexible allowing the consumer to adapt said structure to their needs for their facility. Therefore, all possible functions for a multi-functional module that allow for the proper functioning of the desired facility should therefore be encompassed within the scope of this disclosure.

When a modular building structure, pre-equipped or not, is delivered to the installation site of the facility, appropriate moving equipment known by those skilled in the art may be used to position the modular building structure in the appropriate location within the facility according to design plans. Once correctly positioned, the modular building may be connected, or not, to other modular building structures as well as to the surrounding areas, as described above, to form the facility.

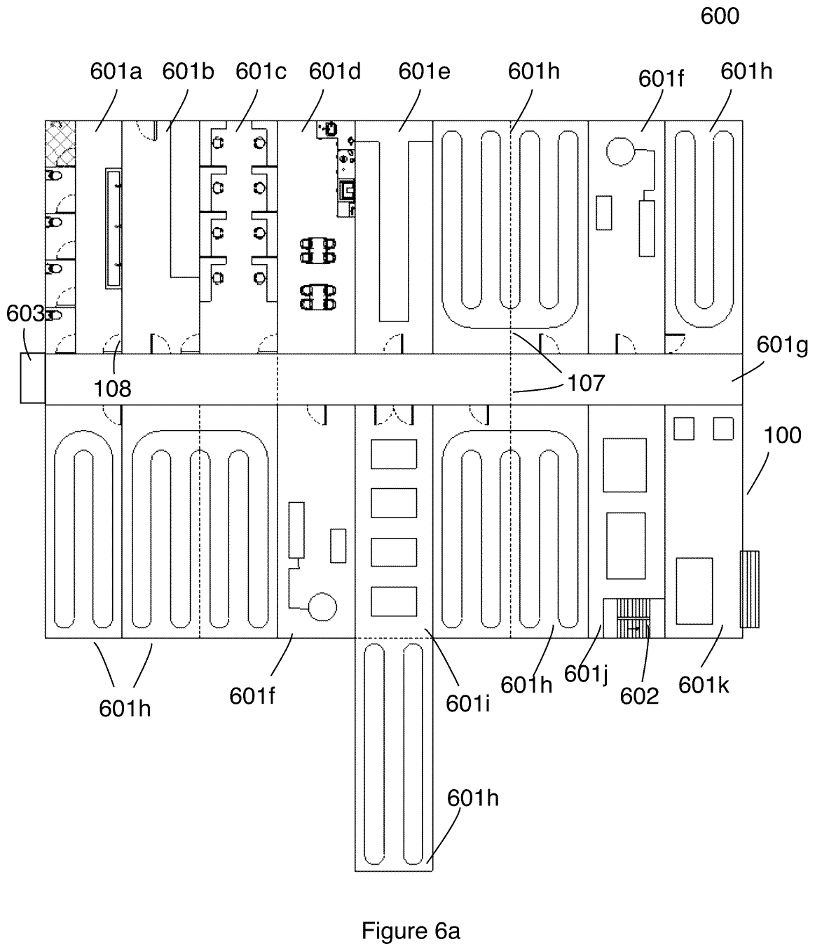

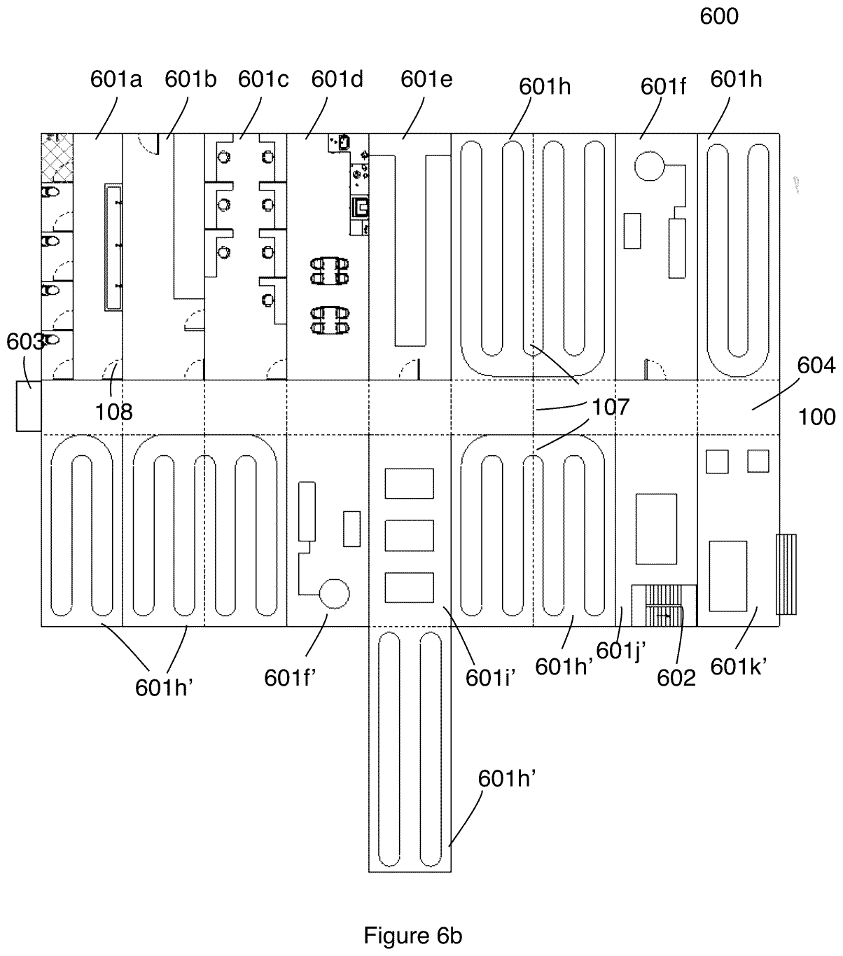

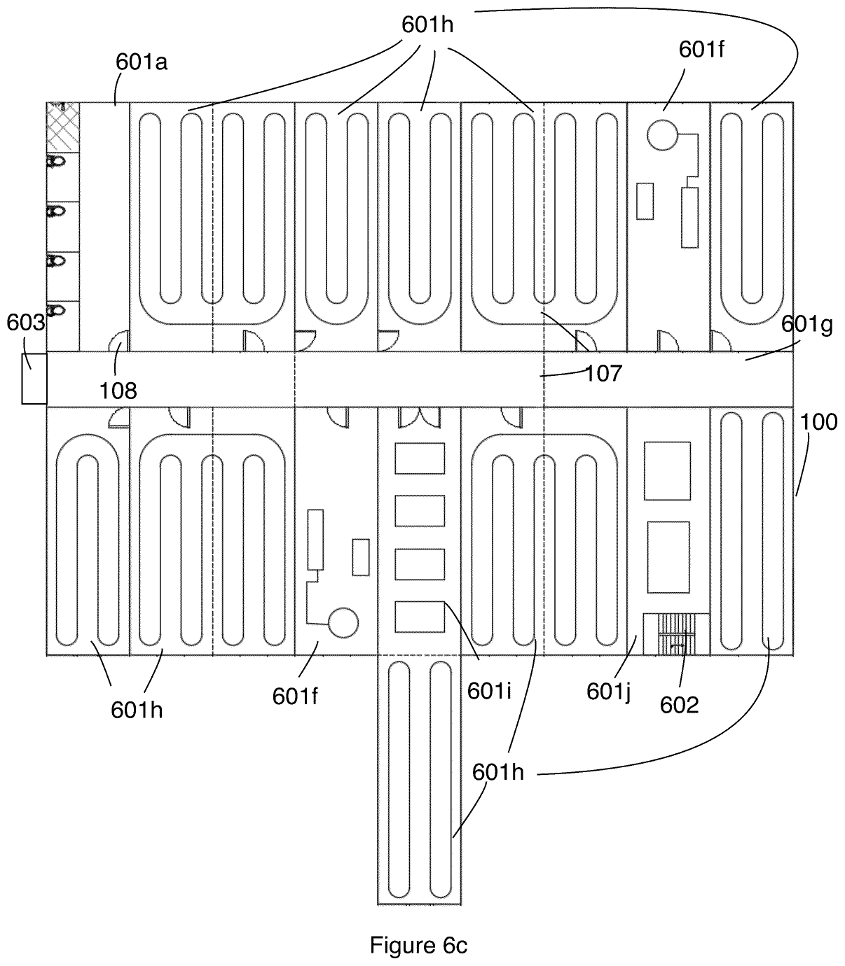

As an exemplary embodiment of the disclosed structure, modules with a dedicated function may be used to form a facility such as the one in FIG. 6a. The facility 600 illustrates modular building structures 100 to form modules attributed dedicated functions required for the functioning of the facility 600. Examples of module functions shown in FIG. 6 are a washroom module 601a, an entrance module 601b, an office module 601c, a lunchroom module 601d, a storage module 601e, a machine room module 601f, corridor modular building structures 601g, indoor farming modules 601h, a processing module 601i, a packaging module 601j and a shipping module 601k. A shipping module is particularly advantageous to allow for easy shipment of products produced in the facility. While these functions have been attributed to modules in the exemplary embodiment of FIG. 6a it should be understood that the presences of the functions mentioned above does not define the facility disclosed herein. A different function than those illustrated in FIG. 6a and listed above may be attributed to a module. Furthermore, the exclusion of certain modules illustrated in FIG. 6a, or the addition of more modules with the same function as a module described, may be required for the proper functioning of the facility. Again, due to the modular nature and potential customization of the modular building structures, it is impossible to describe every possible dedicated function that a module may have within the facility as well as all possible configurations modules make take to form a facility. Specialized equipment for the functioning of a module may be added either before installation or after installation as described above. Specialized equipment may be toilets, sinks, and showers for the washroom module 601a, with appropriate necessary systems such as plumbing and electricity to allow the equipment to work. However, specialized equipment may also be considered a centralized HVAC unit 400 within the machine room module 601f or plant growing apparatuses and conveyor systems for the indoor farming modules 601h, other examples of specialized equipment are known to a person skilled in the art. Dedicated function modules may be particularly advantageous for manufacturing as modular building structures may be pre-equipped before sale due to limited customization options. A washroom module, for example, may always be manufactured with the same components, however, may be customized through the position of the door or passage of entrance. Also, to obtain a proper functionality or shape of modules and thus the overall shape of a facility, walls 106 may be withdrawn. The method to remove said walls 106 may be already considered in the design of the walls 106, as in the case of removable insulating panels 107, or through other methods that allow for their removal, such as the cutting out of sections of the wall with appropriate machinery. Stairs 602, elevators, exterior fire escapes 603, or any other additional necessary elements for the facilities functionality may also be added after installation or conceived as part of a pre-equipped modular structure.

In another embodiment of the disclosed system, multi-functional modules may be used to form a facility such as the one in FIG. 6b. The facility 600 illustrates modular building structures 100 attributed multiple functions to form modules as described above. Examples of module functions shown in FIG. 6b are a washroom module 601a, an entrance module 601b, an office module 601c, a lunchroom module 601d, a storage module 601e and a machine room module 601f. Also, indoor farming modules 601h′, a processing module 601i′, a packaging module 601j′, a machine room module 601f′ and a shipping module 601k′ designed with a dedicated space for a corridor 604 may be added. While these functions, and combination of functions, have been attributed to modules in the exemplary embodiment of FIG. 6b it should be understood that the presence of the functions and combinations mentioned above does not define the facility disclosed herein. A different function, or combination of functions, than those described above and illustrated in FIG. 6b, may be attributed to a module. Furthermore, the exclusion of certain modules illustrated in FIG. 6b, or the addition of more modules with the same function or combination of functions as a module described, may be required for the proper functioning of the facility. Again, due to the modular nature and potential customization of the modular building structures, it is impossible to describe every possible dedicated function that a module may have within the facility as well as all possible configurations modules may take to form a facility, other variations of beneficial multi-functional modules that allow for proper functioning of the desired facility are known to a person skilled in the art. As opposed to the embodiment describing a facility comprising of dedicated function modules, the use of these types of modules allows for a plethora of customization options to be manufactured. The modules within the system may be designed to only use the required space needed for a certain function within a facility, therefore allowing for the construction of a facility in which allotted space for certain activities is not exaggerated, as may be the case when more limited customization options are available. Specialized equipment for the functioning of a module may be added either before installation or after installation as described above for a dedicated function module. To obtain a proper functionality or shape of modules and thus the overall shape of a facility, walls 106 may also be withdrawn in a way akin to the methods described for dedicated function modules particularly to allow dedicated corridor space within a modular building structure to continue through multiple modular building structures through openings in side walls. Other additional necessary elements for the facilities functionality may also be added after installation or conceived as part of a pre-equipped modular structure as described above.

Another embodiment of the facility may be the combination of both multi-functional and dedicated function modules to be used to form a facility.

Another embodiment may allow the facility to have multiple levels, depending on the support limitations of the modular building structure. An example of an additional level floor plan shown in FIG. 6c.

As mentioned above, a large variety of configurations for an indoor farming unit 500 may allow optimal foliage density for the objectives of the unit, such as the one described in patent “Apparatus for Growing Plants”, CN102387700A, published Mar. 21, 2012. In this prior art the system moves parallel to the horizontal axis of the indoor farming module in a serpentine loop rather than parallel to the vertical axis of the unit described in the previously presented prior art. A loop herein shall be defined as the layout of the plant growing apparatuses within the indoor farm module consisting of a plurality of straight track portions connected at each end to adjacent track portions by a curved portion, which may include a serpentine loop, a spiral loop, a single elliptical loop, or any other arrangement to strategically limit the loss of plant cultivation area while allowing continuous movement within the designed loop path. These configurations are known in the prior art.

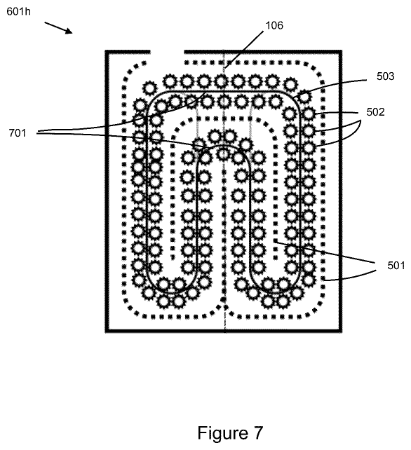

Regarding the present disclosure, the indoor farming unit 500 may be installed within a modular building structure at the installation site of the disclosed facility, however in the case of pre-equipped modular building structures described above, essential systems for plant growth 501, plant supports 502 and possible conveyor systems 503 may already be installed within before installation. To create a module that is the equivalent useful size of at least two modular building structures 100 and containing a continuous conveyor path as to prevent the loss of space efficiency within the module, as shown in FIG. 7 removable walls 106 may be removed from the modular building structures. Furthermore, to create the continuous conveyor path spanning multiple modular building structures, conveyor links 701 may be fitted during installation to redirect components in a desired loop path. These conveyor links 701 may be considered to be specialized directional guides that change the trajectory of the pre-equipped conveyor systems 203.

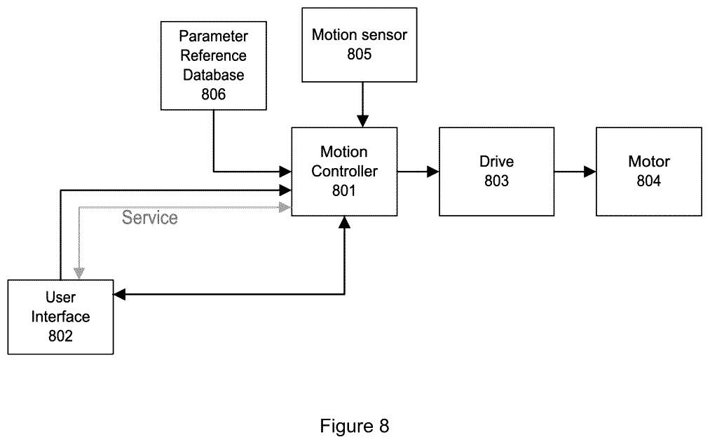

As described in prior art, the application a conveyor system may allow plants to travel at a constant speed throughout the conveyor path to ensure that each plant within an indoor farming unit 500 experiences the same growing conditions with manually powered systems, motorized systems or other mechanisms known by those skilled in the art. Once plants need to be attended to, a worker may stop the conveyor system, by using a control panel or other user interface (tablet, iPad, mobile application, remote . . . ) for example, and restart the motion once their tasks are completed. However, in the case that there are no major fluctuations within the designated growth area, the system may be stationary during normal operational conditions and the worker may move the conveyor to transport habitually non-accessible plants close to a workstation. The workings of the conveyor system may be illustrated further in FIG. 8. A motion controller 801 may be associated to the user interface 802 to allow a worker to move or stop the plant growing apparatuses along the conveyor system. The motion controller 801 may control the drive 803 of the conveyer system instigating the motor 804 to produce the force necessary to propel mobile systems throughout the indoor farming unit. This motion may further be controlled through motion sensors 805 and reference data 806. If any of the essential systems for plant growth or if a structural element of modular building structure 100 require any maintenance within the designated growth area, thus being inaccessible without the disclosed method described below, the issue may be displayed on the user interface 802 through a service request. The worker may then be able to identify the location that requires maintenance and indicate to the user interface 802 to bring a desired portion of indoor farming module to the workstation. Furthermore, as described below, the worker may control the motion of the indoor farming module when they are within said system to be able to access a desired location during maintenance as described below in the disclosed method.

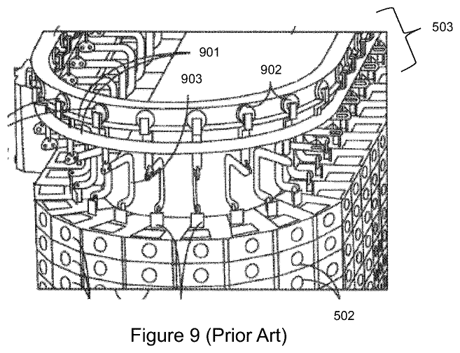

Different variations of the conveyor system presented in the reference may include a manually powered system, a motorized system or another mechanism known by those skilled in the art. As described above, movement of plant growing apparatuses and associated systems within the indoor farm may permit the plants to experience normalized growth condition and prevent the need for a worker to physically move within the indoor farming module to preform required tasks. In the case that the conveyor system is motorized, a worker may simply indicate through a user interface 802 the direction in which the conveyor should move with the help of a motor 804 thus not requiring any physical effort from the worker. The electricity provided to such a system may be providing through electrical wiring or through an electrical grid installed to the ceiling. In another case, the conveyer system may be moved manually by the worker, thus avoiding the need for additional equipment. It should be appreciated that this system may use a variety of mechanisms to allow continuous motion within the cultivation area. As shown in FIG. 9 from patent “Environmentally Controlled Vertical Farming System”, U.S. Pat. No. 10,306,847 B2 published Jun. 4, 2019, the conveyor system may include directional guides 901 which may direct the path to be followed through the use of tracks, rails, slots or other mechanisms known by those skilled in the art. Furthermore, the conveyor system may include a mobility component 902 such as wheels, balls, gears or other mechanisms known to those skilled in the art to allow freedom of motion to the mobile system once a force is acted upon it. The conveyor system may further comprise of an attachment component 903 that secures a plant growing apparatus and associated systems to the conveyor system. Furthermore, the conveyor system may be installed above, below or in another strategic location of the mobile indoor farming module allowing for certain design characteristics of each placement to therefore be exploited.

An embodiment of an attachment component 903 may include a mechanism which allows a segment of the secured system to rotate as shown in FIG. 10. A segment 1001 may be considered to be comprised of a structural unit that contains at least one plant, at least one component of an essential system for plant growth or a combination of a structural unit that contains at least one plant and at least one component of an essential system for plant growth. The addition of said rotational mechanism 1002 to the attachment component 903 provides an advantage when faced with a double-sided plant growing apparatus described in more detail below. A worker may stay at the designated workstation, direct the conveyor system to bring a certain part of the indoor farming module in front of them, perform necessary tasks on the exposed portion, proceed to turn a segment of the indoor farming module to expose components on the protected inaccessible side and complete necessary tasks on the originally protected portion. The rotational mechanism 1002 may also facilitate motion for the conveyor system. The rotational mechanism may be installed above, below or in another strategic site of the indoor farming module allowing for certain design characteristics of each placement to therefore be exploited. The rotational mechanism may consist of a ball joint, a swivel, a chain, circular tracks, a pivot, a bearing, a universal joint, a combination of the previously named elements, or other elements or combination of elements that may allow a segment to be rotated. Furthermore, the rotation that may be permitted through the addition of said elements may allow free rotational movement of the segment while being transported by the conveyer system for reasons including the equal exposure to growth conditions. The rotational motion of the segment may also be restricted through the use of latches, locks, pins or other mechanisms to secure the system in place. This may prevent the segment from rotating freely while being transported by the conveyer system and only be rotated at a desired location, then may precede to be restricted to its secured state. Depending on the design and functionality attributed to the rotational mechanism, appropriate space around the rotating segment needs to be granted.

A growing apparatus within the indoor farming module in the present disclosure may in one embodiment take the form of at least one vertical growth column as known in the state-of-the-art https://canobi.one. Herein a vertical growth column may be considered to be an independent singular column which contains at least one plant within a plant containment vesicle. This plant growth apparatus may be modular, thus allowing it to contain multiple repetitions of independent vertical growth column units with a certain structural configuration. Each vertical growth column may be manipulated, controlled, and maintained independently from other vertical growth columns within an indoor farm or groups of at least two vertical growth columns may be coordinated together to be manipulated, controlled, and maintained together. The plants within a vertical growth column may be considered individually or as an ensemble which may depend on nutrients being delivered through soil or a hydroponic system, lighting systems, irrigation system and other essential systems for plant growth as described above. Vertical growth columns may be suspended with an overhead support system, supported through a base or a combination of both depending on the type of motion required of the indoor farming module and design of the conveyor system. Vertical growth columns may be accorded a certain freedom of motion including but not limited to rotational or linear motion depending on the design of the conveyer system to provide easier access to plants. The motion of the vertical columns may allow them to move easily throughout the loop path. Moreover, the vertical growth column may include certain essential systems for plant growth within itself, however essential systems for plant growth may be external to the plant growing apparatus and service a portion of the designated growth area. Other variations of the plant growth apparatus described above including variations or equivalents to the system above are known to those skilled in the art and should be considered to apply to the disclosed system and method.

The disclosed system may also be used in conjunction with a plant growth apparatus which takes the form of a vertical growth wall such as the one from patent “Environmentally Controlled Vertical Farming System”, U.S. Pat. No. 10,306,847 B2 published Jun. 4, 2019. The definition of a vertical growth wall herein may include variations where this plant growth apparatus may be modular, thus allowing it to contain multiple repetitions of a single unit with a certain structural configuration. Vertical growth walls may provide support for at least one plant within a plant containment vesicle to grow vertically. Each vertical growth wall may be manipulated, controlled, and maintained independently from other vertical growth walls within the plant growth apparatus of the indoor farm or groups of at least two units may be coordinated together to be manipulated, controlled, and maintained together. The plants within one of these vertical growth walls may be considered individually or as an ensemble which may depend on nutrients being delivered through soil or a hydroponic system, lighting systems, irrigation system and other essential systems for plant growth as described above. The vertical growth wall may be suspended with an overhead support system, supported through a base or a combination of both. The vertical growth wall may be accorded a certain freedom of motion including but not limited to rotational or linear motion depending on the design of the conveyer system. The motion of the vertical columns may allow them to move easily throughout the loop path. Moreover, the vertical growth wall may include certain essential systems for plant growth within itself, however essential systems for plant growth may be external to the plant growing apparatus and service a portion of the designated growth area. Furthermore, vertical growth walls may be considered as at least two vertical growth columns which are adjoined and associated together. Other variations of the plant growth apparatus described above are known to those skilled in the art and should be considered to apply to the disclosed system and method.

The disclosed system may also be used in conjunction with a plant growth apparatus which takes the form of a vertical stack plant assembly as from patent “Automated Indoor Cannabis Growing Facility and Methodology” US20190191639 A1, published Jun. 27, 2019. The definition of a vertical stack assembly herein may include variations where this plant growth apparatus may be modular, thus allowing it to contain multiple repetitions of a single unit with a certain structural configuration. Vertical stack plant assemblies may contain a horizontal shelf in which at least one plant within a plant containment vesicle may be placed. Each vertical stack plant assembly may be manipulated, controlled, and maintained as an independent unit from other vertical stack plant assemblies within an indoor farm or groups of at least two units may be coordinated together to be manipulated, controlled, and maintained together. The plants within one of these vertical stack plant assemblies may be considered individually or as an ensemble which may depend on nutrients being delivered through soil or a hydroponic system, lighting systems, irrigation system and other essential systems for plant growth as described above. The vertical stack plant assembly may be suspended with an overhead support system, supported through a base or a combination of both. The vertical stack plant assembly unit may be accorded a certain freedom of motion including but not limited to rotational or linear motion depending on the design of the conveyer system. The motion of the vertical columns may allow them to move easily throughout the loop path. Moreover, the vertical stack plant assembly may include certain essential systems for plant growth within the unit, however essential systems for plant growth may be external to the plant growing apparatus and service a portion of the designated growth area. Within a vertical stack plant assembly an individual horizontal shelf may be considered independent from the rest. Multiple shelfs may be stacked together to reap the benefits of utilizing vertical space. Other variations of the plant growth apparatus described above are known to those skilled in the art and should be considered to apply to the disclosed system and method.

While designing an indoor farming unit 500 in such a way as to maximize foliage density is known in the prior art, the innovations that grant this feature often prevent access to certain areas within the confined indoor farming unit 500 often by removing all possible passageways within the indoor farming unit 500. Furthermore, the prior art does not describe a method to render these inaccessible areas accessible if any of the essential systems for plant growth or any structural element of modular building structure 100 require any maintenance within said inaccessible area for example.

In order to rectify this problem, a method to access areas of an indoor farming module designed in such a way that may render some areas inaccessible within, while having a minimum impact on the other components or functionalities of said indoor farming unit 500 is proposed below. In order to be able to execute this method, parts of the system found within the indoor farming module that are mobile, through a conveyor system or other mechanisms that synchronized the motion of segments with the other mobile segments within the indoor farming unit 500, to be withdrawn without impacting other segments of systems within the indoor farming unit 500. The withdrawal may be done through a detachment or disassembling of a segment from the system. The vacant space created is to be herein referred to as an opening.

In another embodiment of the system, a plant growing apparatus may be conceived to allow segments to be withdrawn from the system without impacting other segments within the indoor farming unit 500 in such a way that the unit does not require any disassembling or detachment. This may be done through a separate guiding system that may be used only when segments need to be withdrawn. The withdrawn segments may create an opening.

In some embodiment, the plant growing apparatus of the indoor farming unit can be conceived to allow the detachment or withdrawal of a successive segment to add to the opening created after the detachment or withdrawal of the prior segment rather than creating a different independent open space.

In another embodiment of the disclosed system, a permanent opening may be conceived within the system. A user interface or other mechanism may allow this opening to be brought to a specific point.

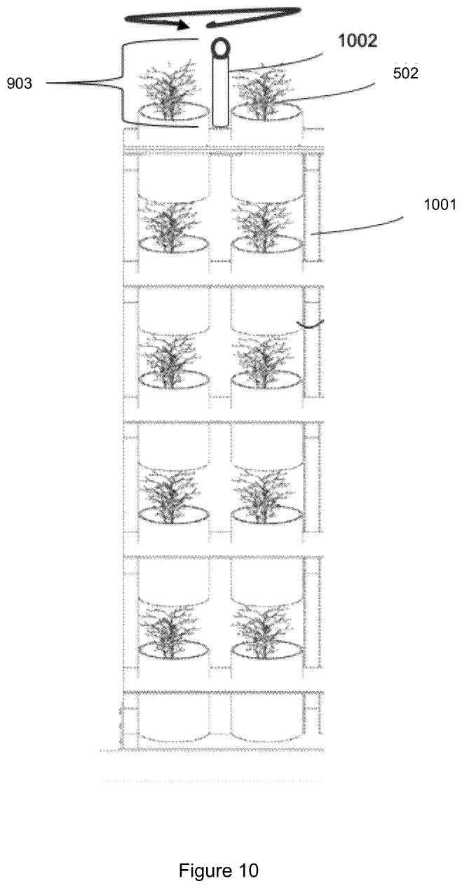

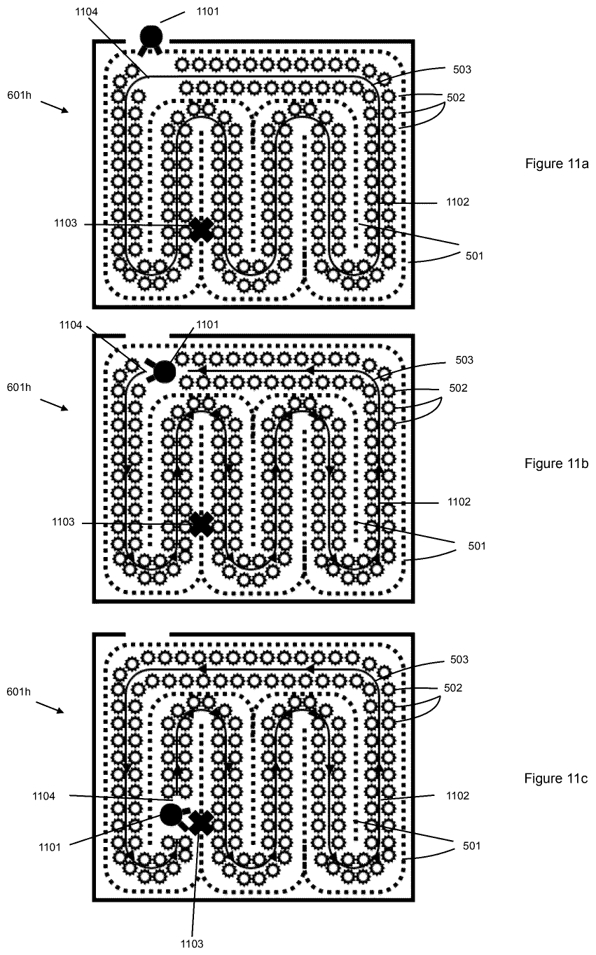

In an exemplary embodiment of the proposed method suggests, as illustrated in FIG. 11a, the occurrence of a failure within an indoor farming module 601h that may not accessible due to the layout of the indoor farming unit 500. In the suggested circumstance, the module is filled in such a way that it does not allow a worker 1101 to pass due to the absence of passage space. The term worker herein should be understood to include any equipment that might be needed to execute a task within an indoor farm, wherein the equipment may be fully or partially autonomous, such as a robot, a device controlled remotely or a manually controlled device, as well as a living organism able to perform tasks. The proposed method described herein presents a solution, in case there is an emergency, mechanical failure, or other situation that requires access to a specific location inside the indoor farming module 601h where the lack of passage space may render access to this location difficult without the application of said method.

In the present example a stationary light may have burnt-out within the indoor farming module 601h. An alert for maintenance at this location may be signaled through various control systems as described above or may be visible identifiable. Being fixed in place, the light may not be accessible by simply transporting it through the conveyor system. Without a mobile system that may contain an opening, the only manner to access the light may be to remove all segments of the indoor farming module 601h that is blocking a trajectory to the light. A worker 1101 may position themselves in front of the loop path 1102, either at a workstation or another area that allows direct interaction with the system and that holds a relationship to the desired location 1103. The disclosed method may allow access to a desired location 1103, for the purposes of maintenance in the present example, within the indoor farming module 601h through an opening 1104 in the loop path 1102. An opening 1104 may be positioned in front of the worker 1101 either through the use of a user interface or another mechanism described above if said opening 1104 was already existing. The opening 1104 may also be created in response to circumstances of the present example through the removal or withdrawal of segments of the system. It may be understood that the size of the segments absent from the mobile portion of the indoor farming module 601h may allow the opening 1104 to be of appropriate size to permit a worker 1101 to fit comfortably within.

As shown in FIG. 11b, the worker 1101 may then proceed to insert themselves into the loop path 1102 by using the space of the opening 1104. The system may be conceived in such a manner that the inclusion of the worker 1101 within the loop path 1102 may not hinder the motion of the mobile portion of the system.

As shown in FIG. 11c, inside the opening 1104 and the loop path 1102, the worker 1101 may then follow the loop path 1102 while the mobile portion of the system moves until the worker 1101 reaches the desired location 1103 within the indoor farming module 601h. The synchronized motion between worker 1101 and opening 1104 may be controlled through a user interface in such a way that allows the worker 1101 to operate the user interface when inserted inside the opening 1104, such as through the use of a wireless remote, mobile software application or other similar technology. The movement of the worker in correlation to the conveyor system may further be improved through the employment of trolleys, carts, mobile floors, lifts or other systems that may overcome motion barriers due to the design of the mobile system.

The worker 1101 may then arrive at the desired location 1103. At this location the worker 1101 may complete the repair on the burnt-out lightbulb of the exemplary embodiment. The desired location may also be considered to be the best location to exit the opening, however, is not necessarily the exact location where an activity will be performed. If the desired location 1103 is not in the same place as the location of the activity, the worker 1101 may move obstacles, using or without using the space available by the opening 1104, to create a path to the activity location.

After the required tasks are completed, the worker 1101 may return to a position which allows them to be inserted within the loop path 1102. The worker may then follow the loop path 1102 when inside of the opening 1104 in a manner akin to the way in which the worker 1101 arrived at the desired location 1103. It should be understood that the worker 1101 may follow the loop path 1102 until arrived at an additional desired location. This destination may be another location requiring maintenance.

In the case that no more activities need to be performed in the indoor farming module 601h, the worker 1101 may arrive to an exit point where the worker 1101 may exit the loop path 1102. This point may be at the same location where the worker 1101 originally inserted themselves into the system, however it may also be a separate location that is suited to be an exit location. Depending on the configuration of the system, the opening 1104 may then be filled by replacing segments withdrawn from the system.

The embodiments described above within the context of the present invention are presented for illustrative purposes only. It should therefore be acknowledged by those skilled in the art that various alterations and alternative embodiments, possessing equal technical standing, are possible. Therefore, it should be understood that the present invention is not limited to the description detailed herein. Thus, the true scope of technical protection for the present invention must be ascertained in accordance with the technical essence captured in the appended claims. Furthermore, it is explicitly recognized that the invention includes all modifications and equivalents and alternatives falling within the technical scope of the invention, as stipulated by the appended claims.

What is claimed is:

1. An indoor farming facility comprising:
at least two pre-equipped modular building structures configured to be connected together to form said facility;
wherein at least one of said pre-equipped modular building structures are indoor farming units with a use, operation, function or task of growing of plants, said indoor farming units adapted to receive external working fluid;
wherein a remainder of said pre-equipped modular building structures provides:
a) at least one of heating or air conditioning to provide working fluid to said indoor farming units; and
b) a processing area for plant products;
as a use, operation, function or task of said remainder of said pre-equipped modular building structures; and
wherein said facility includes a corridor for accessing at least said indoor farming units and said processing area, and said facility comprises at least one of:
a) a corridor extending across at least some of said pre-equipped modular building structures, said at least some of said pre-equipped modular building structures having at one end a corridor space and said pre-equipped modular building structures having an opening in at least one side wall; and
b) one or more corridor modular building structures adjoined to ends of said pre-equipped modular building structures.

2. The facility as defined in claim 1, wherein at least some of said pre-equipped modular building structures have at one end a corridor space and an opening in at least one side wall such that a corridor extends across said at least some of said pre-equipped modular building structures.

3. The facility as defined in claim 1, wherein said remainder of said pre-equipped modular building structures further provides toilet facilities.

4. The facility as defined in claim 1, wherein said facility further comprises a plurality of corridor modular building structures adjoined to ends of said pre-equipped modular building structures.

5. The facility as defined in claim 1, wherein said facility comprises two or more floors, said remainder of said pre-equipped modular building structures further provides interior staircase equipment.

6. The facility as defined in claim 5, further comprising an exterior fire escape staircase.

7. The facility as defined in claim 1, wherein said remainder of said pre-equipped modular building structures further provides office space partitions.

8. The facility as defined in claim 1 wherein said modular building structure further comprises connection components to adjoin adjacent modular building structures of said facility.

9. The facility as defined in claim 1, wherein said remainder of said pre-equipped modular building structures possess a plurality of different uses, operations, functions or tasks.

10. The facility as defined in claim 1, wherein said modular building structures further comprises a floor with a length and width and a designated grow area filled with said indoor farming units covering most if not all of said floor and extending across all of said width, a plurality of vertical plant growing support structures each having a number of plant receptacles arranged above each other extending from the floor to a ceiling of said modular building structure and a conveyor system arranged to support the plurality of vertical plant growing structures to be movable along at least one loop path such that the plurality of vertical plant growing support structures fill the designated grow area.

11. The facility as defined in claim 1, wherein said facility further comprises a decontamination system located in at least part of one of said modular building structures.

12. A method for constructing a facility comprising:
using a floorplan of said facility to guide building a number of modular building structures at a first factory location;
shipping at least some of said modular building structures to a second factory location for equipping said modular building structures at said second factory location to provide pre-equipped modular building structures able to satisfy a use, operation, function or task indicated by said floorplan;
shipping said number of modular building structures to an installation site; and
connecting said number of modular building structures together to form said facility in accordance with said floorplan.

13. The method as defined in claim 12, wherein some of said modular building structures are equipped at said first factory location to provide pre-equipped modular building structures able to satisfy a use, operation, function or task indicated by said floorplan.

14. The method as defined in claim 12, further comprising shipping at least some of said modular building structures to a third factory location and equipping said modular building structures at said third factory location to provide pre-equipped modular building structures able to satisfy a use, operation, function or task indicated by said floorplan.

15. The method as defined in claim 12, wherein said connecting step further comprises using connection components of said modular building structures to adjoin adjacent modular building structures.

16. The method as defined in claim 12, wherein said connecting further comprises vertically stacking modular building structures in accordance with said floorplan defining multiple floor levels.

17. The method as defined in claim 12, wherein said connecting further comprises connecting said modular building structures of at least a ground floor to ground engaging members.

18. The method as defined in claim 12, wherein said facility is an indoor farming facility, a large set of said pre-equipped modular building structures being grow chambers.
